(19) United States
(12) Patent Application Publication
(10) Pub. No.: US 2025/0191575 A1
(43) Pub. Date: Jun. 12, 2025

(54) SYSTEM AND METHOD FOR VERIFYING AUDIO PROCESSING PIPELINE RESULTS USING AUTOMATED SPEECH RECOGNITION

(71) Applicant: GONG.io Ltd., Ramat Gan (IL)

(72) Inventors: Zeev RANNON, Yehud (IL); Shlomi MEDALION, Lod (IL); Eduard GOLSTEIN, Petah Tiqwa (IL)

(73) Assignee: GONG.io Ltd., Ramat Gan (IL)

(21) Appl. No.: 18/952,407

(22) Filed: Nov. 19, 2024

Related U.S. Application Data
(60) Provisional application No. 63/607,977, filed on Dec. 8, 2023.

(51) Int. Cl. G10L 15/00; G10L 15/065

(52) U.S. Cl. CPC G10L 15/005; G10L 15/065

(57) ABSTRACT

A system and method for verifying audio processing pipeline results using automated speech recognition. Language identification is performed on audio content in order to identify languages being spoken in the audio content. Selections related to ASR, such as selecting the ASR models or the preprocessing steps to use for ASR, are made based on the identified languages. One or more ASR models are applied in an ASR process. Results related to ASR such as the languages used for ASR selections, the selected models, or the selected preprocessing steps, are verified based on outputs of the ASR models. The verification results may be used for subsequent processing, for example, by deciding whether ASR results should be used for subsequent audio processing.

### CROSS-REFERENCE TO RELATED APPLICATIONS

This application claims the benefit of U.S. Provisional Patent Application No. 63/607,977 filed on Dec. 8, 2023, the contents of which are hereby incorporated by reference.

### TECHNICAL FIELD

The present disclosure relates generally to automated speech recognition, and more specifically to verifying quality of audio processing pipeline results using automated speech recognition.

### BACKGROUND

Automated speech recognition (ASR) is a computational process for identifying specific words and phrases spoken in audio. Performance for ASR may depend on various factors such as determining and classifying the spoken language, as well as selecting the correct acoustic and language models suitable for the spoken language in the acoustic and linguistic domains. Correct language identification (LID) is essential for the performance of ASR when no other source is available on the spoken language (such as voluntary user input).

Language identification aids in automating speech recognition processes. However, there are some notable challenges in LID. One such challenge is that errors in language detection can cause further errors in subsequent processing such as detection on nonsense text when LID outputs are fed into automated speech recognition (ASR) and decision errors using this text for natural language processing (NLP) tasks. Notably, LID models are often classifiers trained based on signal statistics which can face performance challenges related to inaccurately identifying languages.

Solutions which prevent using erroneous LID decisions, for fixing erroneous LID decisions, and for preventing the use of inappropriate speech recognition pipeline results in general are therefore desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for audio processing verification. The method comprises: applying a language identification (LID) model to audio content in order to obtain a set of LID results, wherein the LID model is configured to output at least one language prediction for the audio content; applying at least one audio speech recognition (ASR) model to the audio content based on the set of LID results in order to generate a set of ASR outputs, wherein the set of ASR outputs include a language score and a plurality of predicted words, wherein each ASR model is configured to analyze the audio content with respect to the at least one language prediction output by the LID model for the audio content; and verifying an audio processing result based on the set of ASR outputs.

Certain embodiments disclosed herein also include a non-transitory computer-readable medium having stored thereon causing a processing circuitry to execute a process, the process comprising: applying a language identification (LID) model to audio content in order to obtain a set of LID results, wherein the LID model is configured to output at least one language prediction for the audio content; applying at least one audio speech recognition (ASR) model to the audio content based on the set of LID results in order to generate a set of ASR outputs, wherein the set of ASR outputs include a language score and a plurality of predicted words, wherein each ASR model is configured to analyze the audio content with respect to the at least one language prediction output by the LID model for the audio content; and verifying an audio processing result based on the set of ASR outputs.

Certain embodiments disclosed herein also include a system for [to be completed based on final claims]. The system comprises: a processing circuitry; and a memory, the memory containing instructions that, when executed by the processing circuitry, configure the system to: apply a language identification (LID) model to audio content in order to obtain a set of LID results, wherein the LID model is configured to output at least one language prediction for the audio content; apply at least one audio speech recognition (ASR) model to the audio content based on the set of LID results in order to generate a set of ASR outputs, wherein the set of ASR outputs include a language score and a plurality of predicted words, wherein each ASR model is configured to analyze the audio content with respect to the at least one language prediction output by the LID model for the audio content; and verify an audio processing result based on the set of ASR outputs.

Certain embodiments disclosed herein include a method, non-transitory computer-readable medium, or system as noted above or below, further including or being configured to perform the following step or steps: applying at least one model based on the verified audio processing result.

Certain embodiments disclosed herein include a method, non-transitory computer-readable medium, or system as noted above or below, wherein the audio processing result includes the set of LID results, wherein applying the at least one model includes performing ASR using the set of LID results.

Certain embodiments disclosed herein include a method, non-transitory computer-readable medium, or system as noted above or below, wherein applying the at least one model includes performing natural language processing using the set of ASR outputs.

Certain embodiments disclosed herein include a method, non-transitory computer-readable medium, or system as noted above or below, wherein the at least one ASR model includes an acoustic model and a language model, further including or being configured to perform the following step or steps: applying the acoustic model and the language model using the set of LID results.

Certain embodiments disclosed herein include a method, non-transitory computer-readable medium, or system as noted above or below, further including or being configured to perform the following step or steps: determining a plurality of language accuracy factors based on the set of ASR outputs; determining a plurality of input features for a classifier based on the language accuracy factors; and applying the classifier to the plurality of input features, wherein the classifier is configured to output at least one score, wherein each score output by the classifier indicates a likelihood that a language prediction of the at least one language prediction is correct, wherein the audio processing result is verified based further on the at least one score output by the classifier.

Certain embodiments disclosed herein include a method, non-transitory computer-readable medium, or system as noted above or below, wherein the set of ASR outputs includes a plurality of likelihoods of a plurality of observed characters at each of a plurality of predetermined time intervals within the audio content, further including or being configured to perform the following step or steps: generating a character likelihoods table, wherein the character likelihoods table includes a likelihood for each of the observed characters at each time interval, wherein the language accuracy factors are determined based on the character table.

Certain embodiments disclosed herein include a method, non-transitory computer-readable medium, or system as noted above or below, further including or being configured to perform the following step or steps: applying a first decoding model and a second decoding model to the character likelihoods table, wherein the first decoding model is configured to generate a sequence of words along a path, wherein the second decoding model is configured to select a token with a highest probability among characters at each of the plurality of predetermined time intervals, wherein the plurality of input features are determined based further on results of the first decoding model and the second decoding model.

Certain embodiments disclosed herein include a method, non-transitory computer-readable medium, or system as noted above or below, wherein the plurality of features includes a number of words per second, wherein the audio processing result is verified based further on the number of words per second.

Certain embodiments disclosed herein include a method, non-transitory computer-readable medium, or system as noted above or below, wherein the set of LID results include at least one language prediction output score, wherein each language prediction output score indicates a likelihood for a respective language prediction of the at least one language prediction.

Certain embodiments disclosed herein include a method, non-transitory computer-readable medium, or system as noted above or below, wherein the at least one ASR model is at least one first ASR model among a plurality of ASR models, further including or being configured to perform the following step or steps: selecting the at least one first ASR model to be applied from among the plurality of ASR models based on the LID outputs.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for verifying audio processing pipeline results according to an embodiment.

FIG. 3 is a flowchart illustrating a method for audio processing decisions verification according to an embodiment.

FIG. 4 is an example likelihood table including values determined via inference of a neural network.

FIG. 5 is a flow diagram illustrating a decoding process utilizing connectionist temporal classification.

FIG. 6 is a flow diagram illustrating an example data flow among logical components which may be utilized for audio processing pipeline results verification in accordance with various disclosed embodiments.

FIG. 7 is a schematic diagram of a verifier according to an embodiment.

### DETAILED DESCRIPTION

The various disclosed embodiments include techniques for verifying audio processing pipeline results such as, but not limited to, languages determined using language identification (LID) models, speech-to-text (STT) results, and the like. The disclosed embodiments utilize automated speech recognition (ASR) outputs determined based on an initial LID decision for audio content in order to verify audio processing results. The verified audio processing results may include, but are not limited to, a language indicated in the initial LID decision, STT results for the audio content, both, and the like. Once the audio processing result is verified as accurate for the audio content, the result may be provided as an input for subsequent processing (e.g., for further ASR or for natural language processing).

More specifically, in an embodiment, an ASR process is applied to audio content based on initial LID results for the audio content. The ASR process may include, but is not limited to, applying an acoustic model and a language model. The result is a set of ASR outputs for the initial LID decision including the outputs of the acoustic model and the language model.

One or more language accuracy factors are determined based on the ASR outputs for the initial LID results. Such language accuracy factors may include, but are not limited to, normalized language score (e.g., as calculated based on the sum of language model scores along a best path of CTC decoding), average difference between text resulting from strong decoding and weak decoding (e.g., an average difference between outputs by CTC decoding with a language model and outputs of greedy decoding), relative number of out-of-vocabulary words (also referred to as nonsense words) as compared to number of in-vocabulary words output by greedy decoding, word rate (e.g., number of words/second output by CTC decoding), combinations thereof, and the like. Determining the language accuracy factors may include, but is not limited to, applying decoding such as greedy decoding and connectionist temporal classification (CTC) decoding. The language accuracy factors may be used as or used to determine features, which in turn are input to a classifier configured to verify whether the LID result is accurate based on the input features. The classifier may be realized using, for example but not limited to, a support vector machine, a random forest, and the like.

More specifically, the outputs of the ASR may include, but are not limited to, likelihoods of observed characters at predetermined time intervals within the audio content. To this end, in some embodiments, a character table may be generated containing a likelihood of each character at each time interval. The character table may be processed by CTC decoding and greedy decoding in order to determine language accuracy factors as noted above.

In some embodiments in which LID results are verified, when verification fails for a top, first, or otherwise best LID result (e.g., a language with the highest score as determined by the LID model), a second-best LID result (e.g., a language with the next highest score as determined by the LID model) may be utilized. In a further embodiment, when verification fails for the best LID result, verification may be repeated for the second-best LID result. If verification succeeds for the second-best LID result, then the second-best LID result may be utilized for subsequent processing.

In this regard, it is noted that LID models tend to be simplified models which analyze acoustics superficially while ignoring some features and contexts. As a classifier based on learned signal statistics, a LID model has performance limitations which may manifest as incorrectly identified language results. Any subsequent processing, including ASR or NLP based on results of the LID model, will also be affected by errors in language identification. This may result in detection of nonsense text by ASR and/or decision errors when using this text for NLP. The disclosed embodiments provide techniques for verifying audio processing results which may be utilized to confirm that the language output by an LID model is the correct language being spoken, to confirm that the correct model and preprocessing steps have been applied, or both, before providing such results for use in subsequent processing, thereby ensuring that subsequent processing is performed based on the appropriate language, models, preprocessing steps, or combination thereof.

In some embodiments, the verification may be utilized before all of the audio has been processed in order to further improve audio processing. In such embodiments, verification may be performed with respect to only a portion of the audio content processing results such that the results thus far can be verified before the full audio content has been processed. Such embodiments allow for rejecting audio processing results faster and without processing the entirety of the audio content, thereby improving accuracy and response time while reducing the amount of computing resources needed to process and verify the entire audio content. As a non-limiting example, language identification may be performed based on a portion of audio content in order to determine if the language identified for that portion is incorrect and, if the language is incorrect, that LID result may not be used when processing the rest of the audio content.

Further, it has also been identified that ASR acoustic models are typically more sophisticated models analyzing, in detail, a wide context, and ASR language models can be leveraged to further increase the context and provide lexical information. Accordingly, the disclosed embodiments leverage ASR models with wider context in order to improve upon initial language verification results, thereby improving accuracy of language identification with minimal increased use of computing resources. Moreover, various disclosed embodiments leverage ASR acoustic models in tandem with ASR language models in order to further improve upon language verification.

Additionally, LID models are capable of ranking results. It has been identified that, when a LID model's top result is incorrect (i.e., the incorrect language), the next best result (e.g., the next ranked result) may be more accurate. To avoid improper secondary language identification, the various disclosed embodiments may be utilized to verify the second-best result when the verification process results in determining that the top result is not the correct language. Verifying the second-best result when the best result is determined to be incorrect may therefore allow for further reducing out-of-vocabulary or other nonsense results.

Also, by using language verification as described herein, LID models can be used more effectively and efficiently. At least some embodiments enable lowering the threshold for language identification (i.e., a threshold value needed to determine that a particular language is present in audio content) while maintaining accuracy of the language identification results post-verification. In some embodiments, LID models which are frequently found to produce inaccurate results (e.g., when languages output by a LID model is not verified more than a threshold number or proportion of times), those LID models may be determined as unreliable and cancelled from subsequent use. Accordingly, various disclosed embodiments may further be utilized to effectively validate LID models themselves in addition to verifying results of those LID models.

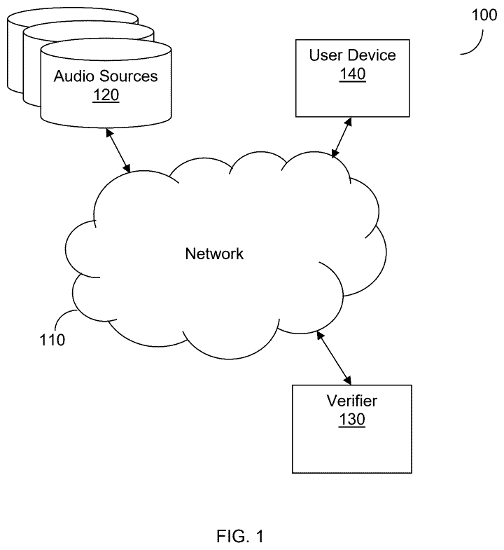

FIG. 1 shows an example network diagram 100 utilized to describe the various disclosed embodiments. In the example network diagram 100, audio sources 120 (hereinafter referred to individually as an audio source 120 and collectively as audio sources 120, merely for simplicity purposes), a verifier 130, and a user device 140 communicate via a network 110.

The network 110 may be, but is not limited to, a wireless, cellular or wired network, a local area network (LAN), a wide area network (WAN), a metro area network (MAN), the Internet, the worldwide web (WWW), similar networks, and any combination thereof.

The audio sources 120 store audio content for language identification and verification as described herein.

The verifier 130 is configured to verify audio processing results such as languages in the audio content determined using language identification (LID) models or speech-to-text (STT) results as described herein. To this end, in accordance with various disclosed embodiments, the verifier 130 is configured to perform language identification on the audio content in order to determine a first set of one or more initial language identification results and to utilize automated speech recognition (ASR) on the audio content based on the initial language identification results in order to verify audio processing results (e.g., the language or languages identified in the initial language identification results or STT results determined using the initial language identification results). When language identification results are verified, the verifier 130 may be configured to determine a second set of one or more language identification results which may be compared to the first set of language identification results to verify whether the first set of language identification results is correct.

The user device 140 may be, but is not limited to, a personal computer, a laptop, a tablet computer, a smartphone, a wearable computing device, or any other device capable of receiving and displaying notifications. In accordance with various disclosed embodiments, results of the verification may be sent to the user device 140 for use in various processes which may utilize identification of languages in audio content such as, but not limited to, automated speech recognition (ASR) and natural language processing (NLP).

It should be noted that the verifier 130 is depicted as a separate system from the user device 140 for example purposes only, and that the disclosed embodiments are not limited as such. As a non-limiting example, instructions for performing any or all of the functions of the verifier 130 may be stored on and executed by the user device 140 such that the user device 140 may perform any or all of such functions without departing from the scope of the disclosure.

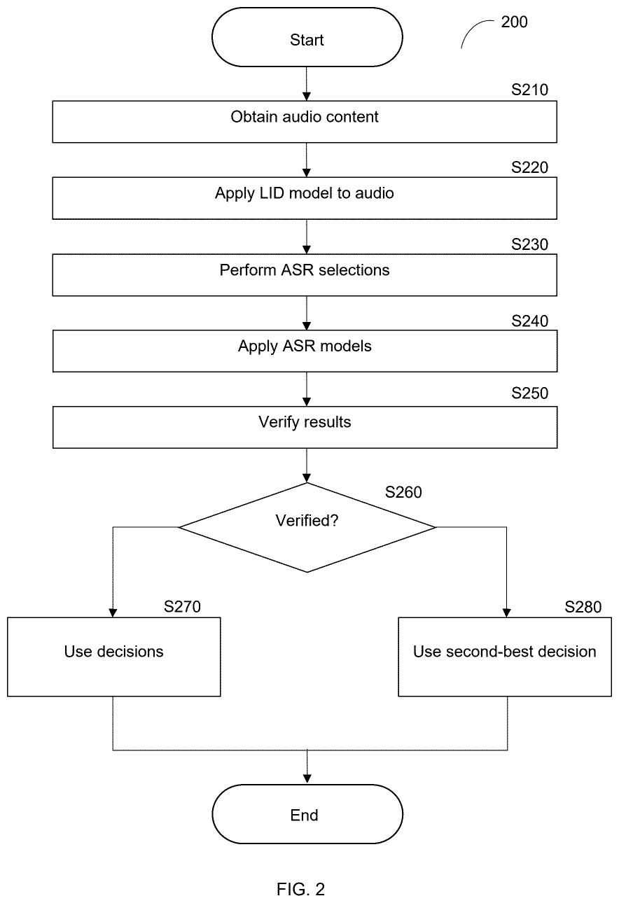

FIG. 2 is a flowchart 200 illustrating a method for verifying language outputs of language identification models according to an embodiment. In an embodiment, the method is performed by the verifier 130, FIG. 1.

At S210, audio content is obtained. The audio content may be obtained from a database (e.g., a database among the audio sources 120), or directly from a device (e.g., the user device 140).

At S220, a language identification (LID) model is applied to at least a portion of the audio content in order to obtain a set of LID results. The LID model is configured to output language predictions for the audio content or portions of the audio content. To this end, the LID model may be configured to output scores indicating likelihoods for respective languages, and the LID results may include these scores or otherwise include the output language predictions. In accordance with various disclosed embodiments, the top language prediction (e.g., the language having the highest score) may be verified via subsequent processing including ASR (e.g., via ASR acoustic and ASR language models).

At optional S230, one or more selections for subsequent automated speech recognition (ASR) processing are performed. The selections may include, but are not limited to, selections of models, selections of preprocessing steps to be performed, both, and the like. For example, ASR models to be used for processing the audio content at S240 may be selected from among a set of potential ASR models based on initial LID results obtained at S220, or a set of preprocessing steps to be performed using the ASR models at S240 may be selected from among potential sets of steps. The models, preprocessing steps, or both, may further be selected based further on other factors such as, but not limited to, channels through which the audio content was obtained, sources of the audio content, and the like.

At S240, one or more automated speech recognition (ASR) models are applied to the audio content using the outputs of the LID model in order to produce a set of ASR outputs or ASR results. Specifically, the ASR models are applied to the audio content with respect to the language predictions represented in the LID results, for example, by using the top language prediction by the LID model as the assumed language for the audio content or otherwise using the language prediction scores output by the LID model. In an embodiment, the applied ASR models are models configured to perform decoding or to provide outputs which may be utilized by decoding models as discussed further below. In a further embodiment, these models include an ASR acoustic model and an ASR language model. In yet a further embodiment, the decoding performed by the ASR models include decoding using a language model and greedy decoding.

In an embodiment, the ASR models output a normalized language score and predicted words. The normalized language scores and rates of out-of-vocabulary words among the predicted words may be utilized as language accuracy features input to the classifier. Alternatively or in combination, outputs of the ASR models may be utilized to determine other language accuracy features such as, but not limited to, average difference between text resulting from strong decoding and weak decoding, relative number of out-of-vocabulary words as compared to number of in-vocabulary words output via greedy decoding, word rate, combinations thereof, and the like.

In a further embodiment, S240 also includes generating one or more supplemental features. In yet a further embodiment, the supplemental features may include a number of words per second output of a language-based ASR model. Alternatively or additionally, S240 further includes applying one or more large language models (LLMs) on the text output by the ASR acoustic and language models in order to obtain the supplemental features, thereby increasing the span of observation to more than one sentence and further improve the accuracy of the subsequent results verification.

At S250, audio processing results of the ASR or of subsequent audio processing based on the ASR results are verified based on outputs of the ASR models. The audio processing decisions may include, but are not limited to, results of applying the LID model at S220, the results determined at S230, both, and the like. Specifically, the outputs of the ASR models may be utilized as features or utilized to generate features for a classifier, where the classifier is configured to detect whether audio processing decisions are correct based on those features. To this end, the classifier may be configured to output one or more scores, where each score output by the classifier indicates a likelihood that a respective language prediction is correct. These scores or other outputs of the classifier may be utilized to verify the audio processing results.

At S260, it is checked whether the results determined at S230 are verified and, if so, execution continues with S270 where those decisions are used for subsequent processing; otherwise, execution optionally continues with S280 where one or more second-best decisions are used.

At S270, when the audio processing decisions or other audio processing results are verified, the audio processing decisions in the results or otherwise the verified audio processing results are utilized for subsequent processing. The subsequent processing may include, but is not limited to, automated speech recognition (ASR), natural language processing (NLP), both, and the like. Using the audio processing results for subsequent processing may include, but is not limited to, applying one or more models (e.g., one or more audio processing or language processing models) to the audio content using the LID results, the ASR outputs, both, and the like. To this end, in a further embodiment, S260 includes applying one or more ASR models, one or more NLP models (e.g., applied to outputs of the ASR models), or both, to the audio content based on the verified language (i.e., using the verified language as the language of the audio content in order to make decisions using models configured to perform such processes).

Because the audio processing decisions are verified in order to ensure that the decisions are accurate, downstream processing errors caused by inaccurate audio processing decisions are avoided, thereby improving the usability of such subsequent processing. As a non-limiting example, errors made due to misidentified language may be avoided.

At optional S280, when the audio processing decisions are not verified, one or more second-best decisions may be utilized. In particular, when the audio processing decisions output a set of potential decisions ranked by likelihood and a highest likelihood decision is not verified, then a second-highest likelihood decision may be used. In some embodiments, S280 may further include verifying the second-best decision and only utilizing the second-best decision when the second-best decision is verified. As a non-limiting example, when a language that had the highest score output by the LID model at S220 is not verified, a language that had the second highest score output by the LID model at S220 may be utilized.

In some embodiments, when the second-best LID result is not verified, subsequent LID request (e.g., third-best and so on) may be subjected to language verification, for example until one of the language results is verified or all potential language results have been exhausted.

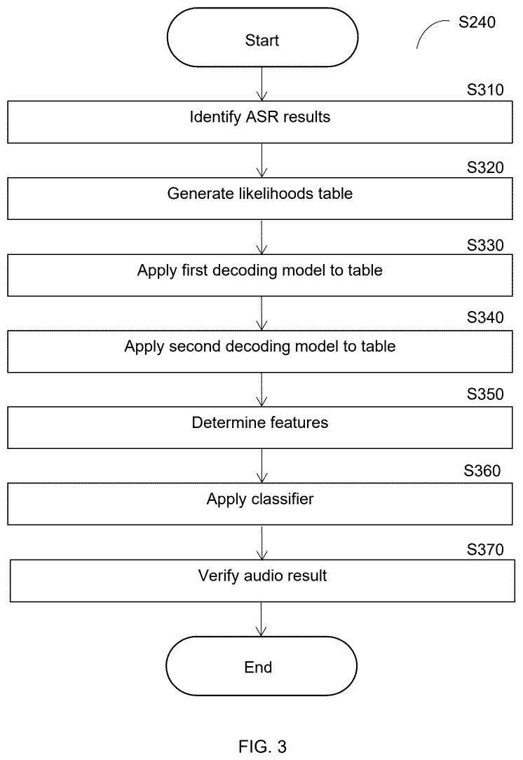

FIG. 3 is a flowchart S240 illustrating a method for audio processing decisions verification according to an embodiment.

At S310, automated speech recognition (ASR) results to be utilized for verification are identified. In an embodiment, the ASR results include results of an ASR acoustic model and of an ASR language model obtained by applying those models to audio content for which the language of the audio content is to be identified (e.g., the ASR results obtained at S230, FIG. 2).

At S320, a likelihoods table is generated. In an embodiment, the likelihoods table is generated by a deep neural network configured to output a likelihoods table based on the audio signal or features calculated from the audio signal.

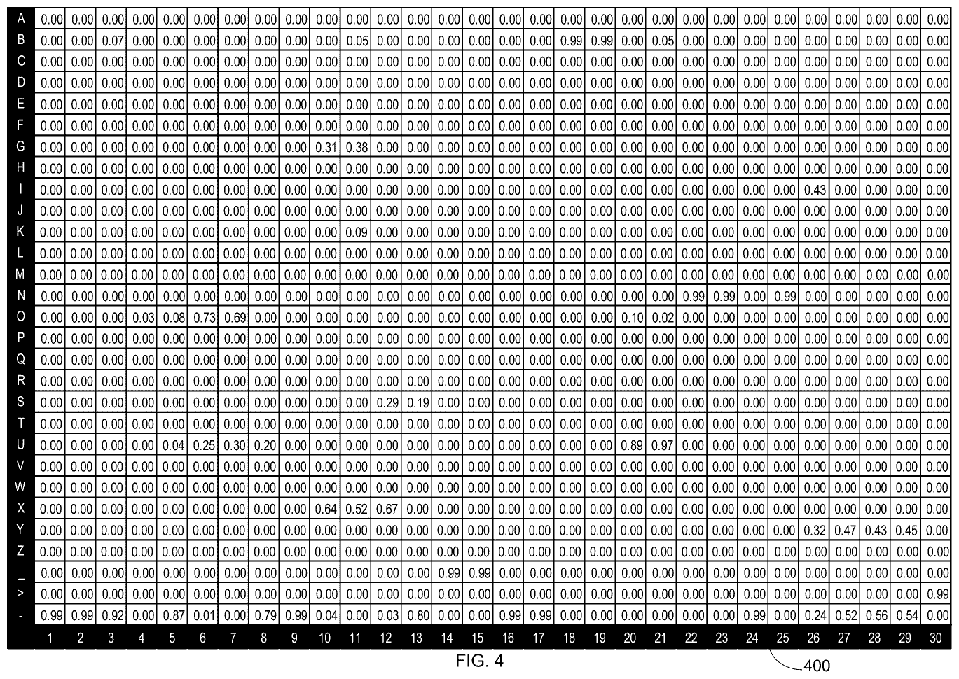

In an embodiment, the likelihoods table is a character likelihoods table including likelihood values for each character among a set of characters for a given language at each of multiple time intervals (i.e., a likelihood for each character at each time interval in the audio content). A non-limiting example of such a character likelihoods table is described further below with respect to FIG. 4.

At S330, a first decoding model configured to decode is applied to the likelihoods table. In an embodiment, the first decoding model is a configured to generate a sequence of words along a best path (e.g., a path having a highest cumulative score along steps of the path). In a further embodiment, the first decoding model has a language model, and the sequence of words generated by the first decoding model is constrained by the weights of the language model. The beam decoding may utilize a dynamic programming algorithm such as, but not limited to, the CTC algorithm.

At S340, a second decoding model configured to decode is applied to the likelihoods table. In an embodiment, the second decoding model is configured to perform greedy decoding including selecting a token (e.g., a token representing a word) with a highest probability among characters at each time interval (e.g., timestep).

It should be noted that S330 and S340 are depicted as being performed in a particular order merely for example purposes, and that these steps may be performed in parallel or in a different order (e.g., applying the second decoding model and then applying the first decoding model) without departing from the scope of the disclosure.

At S350, features are determined based at least partially on the outputs of the decoding by the first and second decoding models. The features may include, but are not limited to, greedy to language model text word error rate (WER) measurements (e.g., defined as the average difference between text resulting from a strong decoding process and a weak decoding process such as CTC decoding with language model vs greedy decoding), normalized language scores, a rate of out-of-vocabulary words (also referred to as nonsense or out of vocabulary words), both and the like. The normalized language scores may be determined based on output of a language model decoding (e.g., the decoding performed by the first decoding model applied at S330). The rate of out-of-vocabulary words may be determined based on outputs of greedy decoding (e.g., the decoding performed by the second decoding model applied at S340). More specifically, such greedy decoding may output a most likely word at different timesteps, and any words output by the greedy decoding which do not belong to a language being verified are determined to be out-of-vocabulary words such that a ratio of out-of-vocabulary words to the total number of words output by the greedy decoding for a given set of audio content is determined as the rate of out-of-vocabulary words.

In a further embodiment, the determined features also include one or more sets of supplemental features. In yet a further embodiment, the supplemental features may include a number of words per second output by a decoding process (e.g., a language model decoding). Alternatively or additionally, the supplemental features may include supplemental features determined by applying one or more large language models (LLMs) on the text output by the ASR acoustic and language models.

At S360, a classifier is applied to the features. In an embodiment, the classifier is configured to output scores indicating respective likelihoods that the language is correct and, consequently, is to be verified. In a further embodiment, the classifier is configured to output two scores: a first score for likelihood that the language is correct, and a second score for likelihood that the language is incorrect. More specifically, the classifier is applied in order to perform language verification based on the outputs of the first and second decoding models.

At S370, based on the outputs of the classifier, it is determined whether a the ASR results are verified for the audio content. In an embodiment, S370 further includes determining whether a language used to select or used by the ASR models is verified, whether the ASR models themselves are verified, whether preprocessing steps used by or with the ASR models are verified, or a combination thereof. In some embodiments, by when the results of ASR are verified, one or more of the preceding factors (e.g., the language, the models themselves, and/or the preprocessing steps) are verified. As noted above, in some embodiments, the classifier outputs a score indicating a likelihood that the results are verified, and the results are verified if the score output by the classifier is above a predetermined threshold; otherwise, the results are not verified.

FIG. 4 is a non-limiting example likelihood table 400 including values determined via inference of a neural network. The example likelihood table 400 illustrates a table of likelihoods for respective characters and, in the particular example shown in FIG. 4, characters of the English alphabet and some special characters which may represent pauses or other non-sound activity (e.g., “_” denoting a delineation between words, “>”, “-” denoting a delineation between characters, etc.). The values in the likelihood table 400 demonstrate a likelihood for each character at a respective time, for example, at respective time intervals. In the non-limiting example shown in FIG. 4, the time intervals are labeled 1 through 30 (i.e., representing a first through thirtieth time interval, respectively). In some embodiments, the likelihood table 400 may be populated based on inferences made using machine learning, for example, using a neural network.

A likelihood table such as, but not limited to, the likelihood table 400 may be utilized for decoding as described herein. For example, greedy decoding may take the character which receives the highest likelihood at each time interval. In the example shown in FIG. 4, a result of the greedy decoding may therefore be “*B*OO**XXX*_**BBUUNN* . . . ”, where * denotes empty character (e.g., a character corresponding to “-” in the table 400). The sequence may be translated into the words “BOX BUN” by deleting repeat characters and using the delineating characters mentioned above in order to construct a resulting phrase.

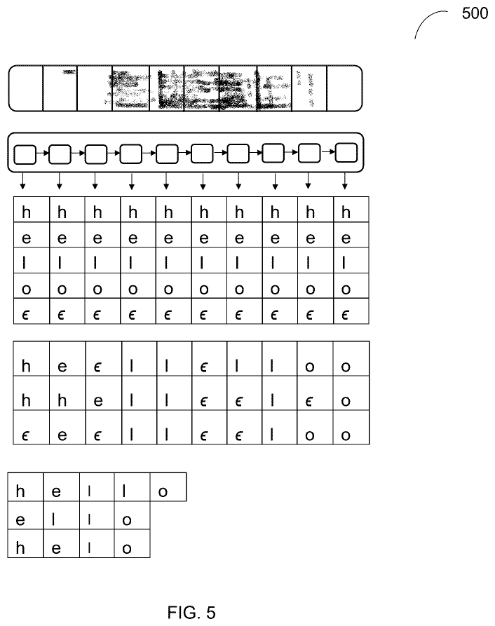

Another decoding process such as CTC beam decoding may make decisions using the likelihood table 400 via a dynamic programming approach (e.g., the CTC algorithm) in which multiple paths are followed connecting the highest likelihoods. Such paths are illustrated in FIG. 5, which is a flow diagram 500 illustrating a decoding process utilizing connectionist temporal classification.

The flow diagram 500 illustrates an implementation in which more than one path can be followed along the best likelihoods, for example resulting with: “hello”, “ello”, and “helo” as potential outputs. In the non-limiting example shown in FIG. 5, the summed likelihoods along the path of “hello” is the highest, and therefore “hello” is selected as the output. A language model such as a tri-gram may be further used to boost more likely word sequences, for example by adding a “language weight” on entering a new word according to past words and the word entered. Furthermore, paths that result in words which are not included among the vocabulary (e.g., invented words) are punished (e.g., via negative weights) to minimize those words.

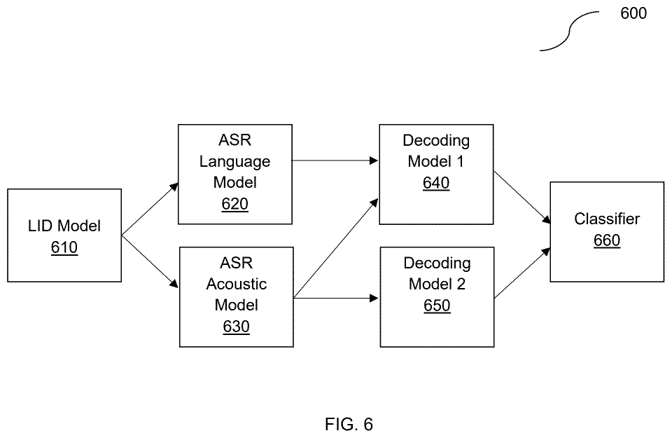

FIG. 6 is a flow diagram 600 illustrating an example data flow among logical components which may be utilized for results verification in accordance with various disclosed embodiments. The example logical components depicted in FIG. 6 may be, but are not limited to, logical components utilized by the verifier 130, FIG. 1.

As depicted in FIG. 6, a language identification (LID) model 610 is applied to audio content (not shown in FIG. 6) in order to yield outputs. The outputs of the LID model 610 are provided in order to select both an automated speech recognition (ASR) language model 620 and an ASR acoustic model 630. More specifically, the outputs of the LID model 610 may serve as a first set of initial language identification results to be verified as described herein. Further, a language output by the LID model 610 (e.g., a top language result output by the LID model 610) may be utilized as the assumed language for ASR processing as follows, for example, by selecting ASR models corresponding to that language.

The ASR language model 620 is applied to the audio content. The ASR language model 620 is provided for decoding. In the non-limiting implementation shown in FIG. 6, The ASR language model 620 is provided to a first decoding model 640.

The ASR acoustic model 630 selected based on the output of the LID model 610 is applied to the audio content. The output from the ASR acoustic model 620, for example a table of likelihoods as discussed above, is provided for decoding. In the non-limiting implementation shown in FIG. 6, these outputs are provided to a first decoding model (decoding model 1) 640 and a second decoding model (decoding model 2) 650.

Each of the first decoding model 640 and the second decoding model 650 may be configured to generate a sequence of output tokens using a respective neural network, for example, using a table of likelihoods produced by the ASR acoustic model 630 such as the non-limiting example likelihood table 400. Such output tokens may represent respective characters such that each decoding model 640 and 650 effectively outputs a sequence of words built from these character sequences.

In an embodiment, the first and second decoding models 640 and 650 are configured to use different decoding algorithms. To this end, in some embodiments, the first decoding model 640 and the second decoding model 650 are a language model (LM) decoding model and a greedy decoding model, respectively. In such embodiments, the beam decoding model 640 is configured to generate a sequence of words along a best path (e.g., a path having a highest cumulative score along steps of the path), and the greedy decoding model 650 is configured to select a token (e.g., a token representing a word) with a highest probability among characters at each time interval (e.g., timestep). The language model decoding may include, but is not limited to, connectionist temporal classification (CTC) beam decoding using a language model.

In this regard, the beam decoding model 640 may function as a normalized language score generator, and the greedy decoding model 650 may function as a detector of out-of-vocabulary words (i.e., a nonsense or otherwise out-of-vocabulary text detector). For the beam decoding model 640, low normalized language scores (e.g., below a predetermined threshold) may be indicative of the wrong language (i.e., language not verified). For the greedy decoding model 650, a high rate of words (e.g., above a predetermined threshold) falling outside of a predetermined vocabulary for the predicted language may be indicative of the wrong language or other mismatching factors in the pipeline. Moreover, outputs of both decoding models 640 and 650 may be utilized to determine word error rate (WER) measurements as discussed herein. As a non-limiting example, a rate of difference between text resulting from both decoding models (e.g., above a predetermined threshold) may be indicative of the wrong language or other mismatching factors in the pipeline.

The beam decoding may utilize a dynamic programming algorithm such as, but not limited to, the Viterbi algorithm. The Viterbi algorithm is designed to obtain the maximum a posteriori probability estimate of the most likely sequence of hidden states that results in a sequence of observed events. According to such an algorithm multiple paths may be followed in order to connect the highest likelihoods. A non-limiting example demonstrating following such paths is discussed above with respect to FIG. 5.

In some embodiments, a language model such as a n-gram may be utilized to boost more likely word sequences for the beam decoding. In such an embodiment, the boosting may be accomplished by adding a language score upon entering a new word according to past words and the newly entered word. Furthermore, when the states traversed indicate certain characters, the paths including those characters which result in words contained in the vocabulary are selected.

In this regard, it is noted that greedy decoding provides simple approximations that can be performed quickly but may be less accurate than slower decoding processes. Beam decoding, which considers a fixed number of potential candidates depending on a predetermined beam width, includes selecting the sequence with the highest joint probability using a set of partially decoded sequences called a beam, with the beam width limiting the number of potential candidates at each timestep. This more advanced algorithm effectively considers multiple candidates at each timestep and retains a set of diverse candidates, which allows for more accurately determining sequences.

By using greedy decoding in tandem with beam decoding as described herein, the results verification is improved as compared to using either algorithm individually. More specifically, the beam decoding may be utilized to identify language and other audio processing pipeline mismatches such as, but not limited to, mismatches between an assumed language and a given word sequence, while the greedy decoding may be utilized to identify language and other pipeline mismatches based on individual out-of-vocabulary words (e.g., gibberish or other nonsense words). Together, the features output by the different decoding processes therefore allow for accurately identifying a higher number of language and other pipeline mismatches, thereby reducing the number of false negatives (i.e., instances in which the language is inaccurately identified as correct). Moreover, comparisons between outputs of the different decoding processes may be utilized to further improve the accuracy of identifying language and other pipeline mismatches.

Additionally, the features output using the respective algorithms of the different decoding processes may be further supplemented with additional features to further improve results verification. In some embodiments, these supplemental features may include a number of words per second output by the beam decoding model 640. In some such embodiments, a low number of words per second output by the decoding model (e.g., a number below a predetermined threshold) may be indicative of a language or other pipeline mismatch (i.e., where a mismatch corresponds to a language not being verified). Alternatively or additionally, other supplemental features may be obtained by applying one or more large language models (LLMs) on the text output by the ASR LM decoding model 640, thereby increasing the span of observation to more than one sentence and further improve the accuracy of the subsequent results verification.

The outputs of the decoding models 640 and 650 are provided to a classifier 660, which is configured to detect the languages in the audio content as described herein. More specifically, the classifier 660 is configured to perform verification based on the outputs of the decoding models 640 and 650 in order to output a second set of language identification results, which in turn are based on ASR analysis of the outputs of the LID model 610. To this end, the classifier 660 may be configured to utilize, for example but not limited to, random forests, support vector machines, and the like.

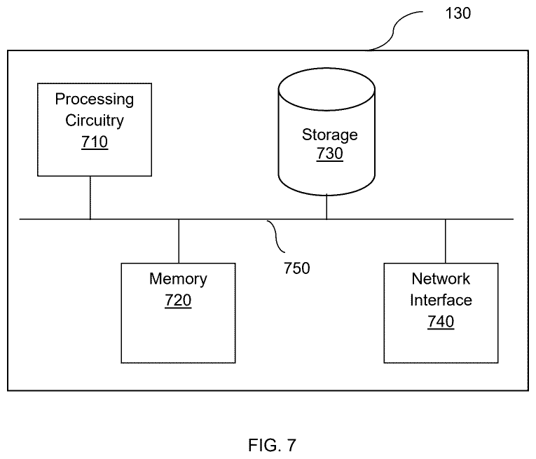

FIG. 7 is an example schematic diagram of a verifier 130 according to an embodiment. The verifier 130 includes a processing circuitry 710 coupled to a memory 720, a storage 730, and a network interface 740. In an embodiment, the components of the verifier 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the verifier 130 to communicate with, for example, the audio sources 120, the user device 140, and the like.

It should be understood that the embodiments described herein are not limited to the specific architecture illustrated in FIG. 7, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 20; 3A; A and B in combination; B and C in combination; A and C in combination; A, B, and C in combination; 2A and C in combination; A, 3B, and 2C in combination; and the like.

What is claimed is:

1. A method for audio processing verification, comprising:
applying a language identification (LID) model to audio content in order to obtain a set of LID results, wherein the LID model is configured to output at least one language prediction for the audio content;
applying at least one audio speech recognition (ASR) model to the audio content based on the set of LID results in order to generate a set of ASR outputs, wherein the set of ASR outputs include a language score and a plurality of predicted words, wherein each ASR model is configured to analyze the audio content with respect to the at least one language prediction output by the LID model for the audio content; and
verifying an audio processing result based on the set of ASR outputs.

2. The method of claim 1, further comprising:
applying at least one model based on the verified audio processing result.

3. The method of claim 2, wherein the audio processing result includes the set of LID results, wherein applying the at least one model includes performing ASR using the set of LID results.

4. The method of claim 2, wherein applying the at least one model includes performing natural language processing using the set of ASR outputs.

5. The method of claim 1, wherein the at least one ASR model includes an acoustic model and a language model, wherein applying the at least one ASR model further comprises:
applying the acoustic model and the language model using the set of LID results.

6. The method of claim 1, further comprising:
determining a plurality of language accuracy factors based on the set of ASR outputs;
determining a plurality of input features for a classifier based on the language accuracy factors; and
applying the classifier to the plurality of input features, wherein the classifier is configured to output at least one score, wherein each score output by the classifier indicates a likelihood that a language prediction of the at least one language prediction is correct, wherein the audio processing result is verified based further on the at least one score output by the classifier.

7. The method of claim 6, wherein the set of ASR outputs includes a plurality of likelihoods of a plurality of observed characters at each of a plurality of predetermined time intervals within the audio content, wherein determining the plurality of language accuracy factors further comprises:
generating a character likelihoods table, wherein the character likelihoods table includes a likelihood for each of the observed characters at each time interval, wherein the language accuracy factors are determined based on the character table.

8. The method of claim 7, wherein determining the plurality of language accuracy factors further comprises:
applying a first decoding model and a second decoding model to the character likelihoods table, wherein the first decoding model is configured to generate a sequence of words along a path, wherein the second decoding model is configured to select a token with a highest probability among characters at each of the plurality of predetermined time intervals, wherein the plurality of input features are determined based further on results of the first decoding model and the second decoding model.

9. The method of claim 6, wherein the plurality of features includes a number of words per second, wherein the audio processing result is verified based further on the number of words per second.

10. The method of claim 1, wherein the set of LID results include at least one language prediction output score, wherein each language prediction output score indicates a likelihood for a respective language prediction of the at least one language prediction.

11. The method of claim 1, wherein the at least one ASR model is at least one first ASR model among a plurality of ASR models, further comprising:
selecting the at least one first ASR model to be applied from among the plurality of ASR models based on the LID outputs.

12. A non-transitory computer-readable medium having stored thereon instructions for causing a processing circuitry to execute a process, the process comprising:
applying a language identification (LID) model to audio content in order to obtain a set of LID results, wherein the LID model is configured to output at least one language prediction for the audio content;
applying at least one audio speech recognition (ASR) model to the audio content based on the set of LID results in order to generate a set of ASR outputs, wherein the set of ASR outputs include a language score and a plurality of predicted words, wherein each ASR model is configured to analyze the audio content with respect to the at least one language prediction output by the LID model for the audio content; and
verifying an audio processing result based on the set of ASR outputs.

13. A system for audio processing verification, comprising:
a processing circuitry; and
a memory, the memory containing instructions that, when executed by the processing circuitry, configure the system to:
apply a language identification (LID) model to audio content in order to obtain a set of LID results, wherein the LID model is configured to output at least one language prediction for the audio content;
apply at least one audio speech recognition (ASR) model to the audio content based on the set of LID results in order to generate a set of ASR outputs, wherein the set of ASR outputs include a language score and a plurality of predicted words, wherein each ASR model is configured to analyze the audio content with respect to the at least one language prediction output by the LID model for the audio content; and
verify an audio processing result based on the set of ASR outputs.

14. The system of claim 13, wherein the system is further configured to:
apply at least one model based on the verified audio processing result.

15. The system of claim 14, wherein the audio processing result includes the set of LID results, wherein applying the at least one model includes performing ASR using the set of LID results.

16. The system of claim 14, wherein applying the at least one model includes performing natural language processing using the set of ASR outputs.

17. The system of claim 13, wherein the at least one ASR model includes an acoustic model and a language model, wherein the system is further configured to:
apply the acoustic model and the language model using the set of LID results.

18. The system of claim 13, wherein the system is further configured to:
determine a plurality of language accuracy factors based on the set of ASR outputs;
determine a plurality of input features for a classifier based on the language accuracy factors; and
apply the classifier to the plurality of input features, wherein the classifier is configured to output at least one score, wherein each score output by the classifier indicates a likelihood that a language prediction of the at least one language prediction is correct, wherein the audio processing result is verified based further on the at least one score output by the classifier.

19. The system of claim 18, wherein the set of ASR outputs includes a plurality of likelihoods of a plurality of observed characters at each of a plurality of predetermined time intervals within the audio content, wherein the system is further configured to:
generate a character likelihoods table, wherein the character likelihoods table includes a likelihood for each of the observed characters at each time interval, wherein the language accuracy factors are determined based on the character table.

20. The system of claim 19, wherein the system is further configured to:
apply a first decoding model and a second decoding model to the character likelihoods table, wherein the first decoding model is configured to generate a sequence of words along a path, wherein the second decoding model is configured to select a token with a highest probability among characters at each of the plurality of predetermined time intervals, wherein the plurality of input features are determined based further on results of the first decoding model and the second decoding model.

21. The system of claim 18, wherein the plurality of features includes a number of words per second, wherein the audio processing result is verified based further on the number of words per second.

22. The system of claim 13, wherein the set of LID results include at least one language prediction output score, wherein each language prediction output score indicates a likelihood for a respective language prediction of the at least one language prediction.

23. The system of claim 13, wherein the at least one ASR model is at least one first ASR model among a plurality of ASR models, wherein the system is further configured to:
select the at least one first ASR model to be applied from among the plurality of ASR models based on the LID outputs.
